(19) United States
(12) Patent Application Publication
(10) Pub. No.: US 2005/0073106 A1
(43) Pub. Date: Apr. 7, 2005

(54) Brush seal support for turbine applications

(75) Inventors: Anthony Constantine Thermos, Greer, SC (US); Chris Basil Jiomacas, Greenville, SC (US); Thomas Edward Wickert, Simpsonville, SC (US); Cletus David Moorman, Simpsonville, SC (US)

Correspondence Address: Lowe Hauptman Gilman & Berner LLP, 1700 Diagonal Road Suite 300, Alexandria, VA, 22314, US

(73) Assignee: GENERAL ELECTRIC COMPANY, Schenectady, NY (US)

(21) Appl. No.: 10/677,310

(22) Filed: Oct. 3, 2003

(51) Int. Cl. F16J 15/447

(52) U.S. Cl. 277/413

(57) ABSTRACT

The brush seal support includes a plurality of female threaded apertures for receiving a male threaded pin or set screw directly threaded to the aperture and staked to the stationary component or threaded to a wire insert, in turn threaded to the aperture. The pin or set screws engage at their distal ends the base of the brush seal segment to maintain the brush seal segment in engagement with the hooks of the groove formed in the stationary component. In this manner, the brush seal is accurately located within the groove and the pins or set screws stabilize the brush seal, preventing flutter and thereby enhance the sealing performance.

### BACKGROUND OF THE INVENTION

The present invention relates to supports for brush seals at various locations within a turbine and particularly relates to supports for brush seals whereby the bristle tips are located accurately and maintained in accurate locations during turbine operation in relation to a sealing surface.

Brush seals having been proposed and constructed in the past and are typically employed for sealing between stationary and rotating components. While certain seals are preloaded by springs, other seals are installed without any supporting structure. Specifically, brush seals typically comprise a base mounting the bristles with the bristle tips projecting distally from the base. The brush seal is conventionally mounted by sliding the base along a premachined groove in a support structure, for example, the inner barrel of a turbine or the inner wall of a turbine diaphragm. The expectation is that the machined features of the groove consistently match the dimensions and tolerances used to manufacture the brush seal, including the base, whereby the seal is supported at a predetermined position and achieves the required configuration between the brush seal bristle tips and the adjoining seal surface.

However, it has been found that the brush seal moves radially outwardly during operation of the turbine, allowing the predetermined spacing to vary, thus reducing the expected performance benefit of the brush seals in the turbine. Moreover, at turbine startup, brush seals mounted in the stationary component along the underside of the rotating member, e.g., the turbine rotor, are typically spaced by gravity a further distance from the rotor than the desired predetermined distance, while the converse is true with respect to those brush seals located above the rotating member. As a consequence, there is a need to provide and maintain required and accurate spacing between the bristle tips and the opposing sealing surface, e.g., the rotating rotor, to enhance the performance of the turbine.

### BRIEF DESCRIPTION OF THE INVENTION

In accordance with an aspect of the present invention, there is provided a brush seal between a stationary component and a movable component in a turbine. The stationary component includes a groove having a recess defining a hook, the groove opening toward the movable, e.g., rotatable, component. The seal includes a base mounting a plurality of bristles, terminating in tips for engagement against the movable component to form a seal therewith. The base of the brush seal includes a laterally extending flange disposed in the recess and in engagement with the hook. To maintain the desired consistent accurate location of the base relative to the stationary component, at least a pair of apertures are provided through the stationary component on the side of the groove opposite the groove opening. Pins and, preferably, set screws, are provided in the apertures to engage the base maintaining the flange of the base in accurate and consistent engagement against the hook of the groove throughout the range of operation of the turbine including startup and shutdown. The set screws or pins are fixed in place by staking to the stationary component or by providing a wire insert threaded within each aperture with the set screw screwthreaded relative to the wire insert. In this manner, the pin or set screw is fixed, thereby fixing the location of the bristles relative to the movable member.

In a preferred embodiment according to the present invention, there is provided a seal comprising a brush seal segment including a base having a flange and a plurality of bristles secured to the base having distal tips for engaging a movable member, a mounting structure for the seal having a groove for receiving the base of the brush seal and having a hook, the groove being sized to enable the brush seal bristles to project beyond a surface of the mounting structure to engage the movable member upon engagement of the brush seal flange and the hook, at least a pair of threaded apertures extending through the mounting structure and opening into the groove, a screw threaded into each of the apertures with an end thereof engaging the base to maintain the brush seal flange in engagement with the hook of the base and means connecting between the mounting structure and the screw for securing the screw in the threaded aperture.

In a turbine seal arrangement comprising an inner barrel about a turbine axis and having an arcuate groove opening inwardly toward the axis, the groove including an axially extending recess spaced within and back from the groove opening and defining a hook, a rotor rotatable relative to the inner barrel, a brush seal including an arcuate base disposed within the arcuate groove and a plurality of bristles extending from the base through the groove opening and terminating in tips engaging a sealing surface on the inner barrel, the base having a flange extending axially into the recess and engaging the hook, a pair of apertures extending through the inner barrel into the groove from a side thereof opposite the groove opening, a pin in each aperture engaging a back side of the base away from the groove opening at circumferentially spaced positions about the base to maintain the flange and the hook in engagement with one another and means for securing each pin in the aperture against axial movement relative to and within the aperture to maintain the bristle tips in sealing engagement with the rotor.

In a further preferred embodiment according to the present invention, there is provided a turbine seal arrangement comprising a diaphragm having a generally arcuate inner wall extending about an axis, the inner wall having a groove opening inwardly toward the axis, the groove including an axially extending recess spaced within and back from the groove opening and defining a hook along the diaphragm wall, a rotor rotatable relative to the inner wall, a brush seal including an arcuate base disposed within the groove and a plurality of bristles extending from the base through the groove opening and terminating in tips engaging a sealing surface on the rotor, the base having a flange extending axially into the recess and engaging the hook, a pair of apertures extending through the inner wall of the diaphragm into the groove from a side thereof opposite the groove opening, a pin in each aperture engaging a back side of the base away from the opening at spaced positions along the inner wall to maintain the flange and the hook in engagement with one another and means for securing each pin in the aperture against axial movement relative to and within the aperture to maintain the bristle tips in sealing engagement with the rotor.

### BRIEF DESCRIPTION OF THE DRAWINGS

FIG. 1 is fragmentary cross-sectional view of portions of a rotor and an inner barrel illustrating a brush seal support in accordance with a preferred embodiment hereof;

FIG. 2 is an enlarged cross-sectional view illustrating the brush seal and support therefor;

FIG. 3 is a fragmentary view illustrating a securement between a pin or set screw and a mounting structure;

FIG. 4 is an exploded view of another form of a pin or set screw for securement in a mounting structure to locate the brush seal;

FIG. 5 is a view illustrating a turbine nozzle diaphragm with a brush seal supported therein in accordance with an aspect of the present invention; and

FIG. 6 is an enlarged fragmentary cross-sectional view of the brush seal and its support.

### DETAILED DESCRIPTION OF THE INVENTION

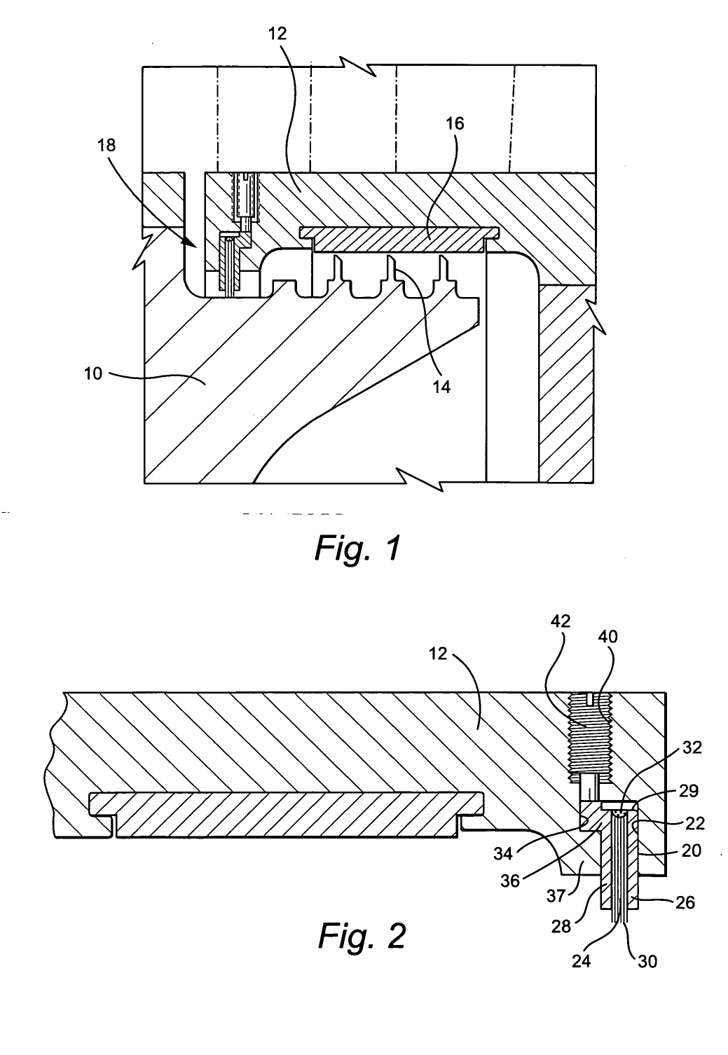

Referring now to FIG. 1, there is illustrated portions of a turbine rotor 10 and an inner barrel 12 for a turbine. The rotor is rotatable about an axis and includes a plurality of labyrinth seals 14 for engaging a sealing surface 16 formed along the inner barrel 12. A brush seal, generally designated 18, also forms part of the seal between the rotor 10 and inner barrel 12 and is located upstream of the labyrinth teeth seals 14. It will be appreciated that the brush seal 18 and labyrinth seals 14 form a high-pressure seal minimizing or eliminating high-pressure compressor air leakage from the compressor into interior portions of the rotor.

Brush seal 18 typically comprises part of an annular array of arcuate brush seal segments 20 (FIG. 2) disposed in a groove 22 of a mounting structure. In the illustrations of FIGS. 1 through 4, the mounting structure comprises the inner-barrel 12. Each brush seal 18 conventionally includes a plurality of bristles 24 extending between a pair of arcuate backing plates 26 and 28, terminating in bristle tips 30 for engagement with a corresponding sealing surface, e.g., the rotor. The bristles 24 are typically secured between the plates 26 and 28 by a weld bead 32 along the arcuate outer side or base 29 of the brush seal 18. In this illustrated aspect of the present invention, the groove 22 opens radially inwardly and also includes a recess 34 extending in an axial direction. The upstream plate 28 of the brush seal 18 includes a flange 36 which forms part of base 29 and which extends into the axial recess 34 overlying hook 37 of the inner barrel 12. It will be appreciated that a plurality of brush seal segments 20 are arranged in the inner barrel with the annular array of tips 30 of bristles 24 of the various segments engaging the rotor 10 to form a seal therewith.

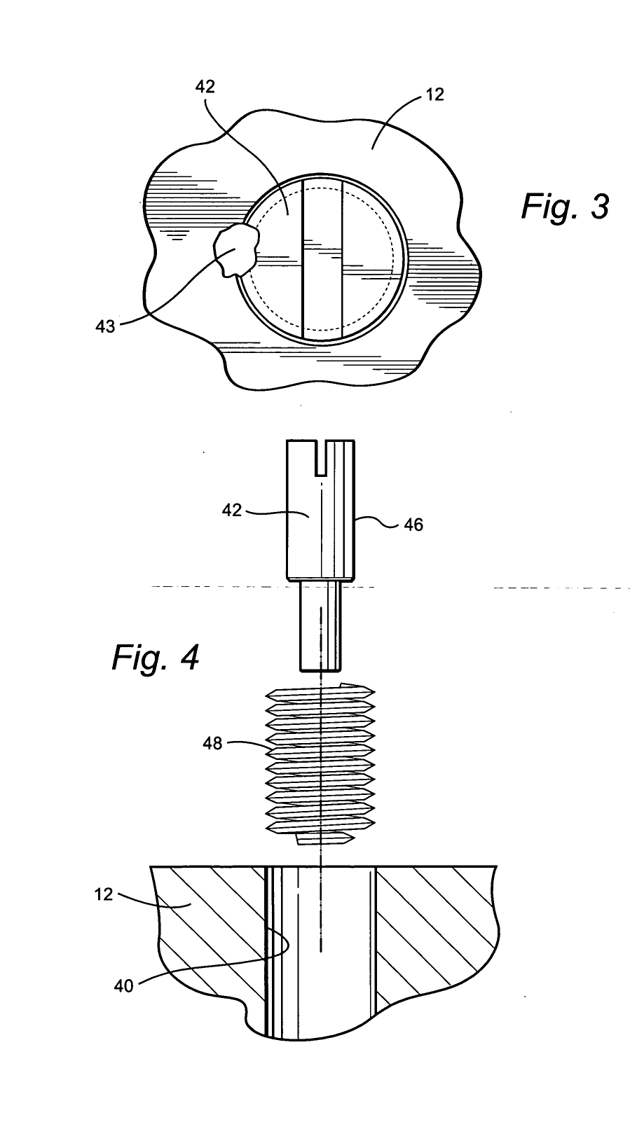

As noted previously, the tolerances and dimensions of the brush seals and machined grooves are such that they do not consistently match one another, consequently permitting movement of the brush seal 18, typically in a radial outward direction relative to the groove. This movement, in turn, causes fluttering and inconsistent performance of the seal. To preclude such relative movement, and in accordance with an aspect of the present invention, a plurality of apertures 40 are formed through the inner barrel at circumferentially spaced positions thereabout and in radial opposition to the flange 36 of the brush seal 18 disposed within the grooves 22. Set screws or pins 42 are disposed within the apertures 40 with inner ends of the set screws or pins 42 engaging the flange 36 of the base of the brush seal 18. The set screws may be threaded directly to female threads along aperture 40 at a predetermined torque load and insertion depth to maintain the brush seal at the required location through the engagement of the set screws and flange 36. As illustrated in FIG. 3, the set screws may be staked at 43 to the mounting structure, i.e., the inner barrel 12, to maintain their axial positions within apertures 40 and, hence, maintain the brush seals accurately located within the brush seal groove 22.

Alternatively, the set screws or pins 42, as illustrated in FIG. 4, may have a male thread 46 for threadedly engaging within a wire insert 48. The insert 48 threadedly engages the female threads of the apertures 40. Thus, the aperture 40 may be oversized to accommodate the threaded wire insert 48. The inner diameter of the insert matches the outer diameter of the screw thread of the set screw 42. By using the combination of the set screw 42 and wire insert 48, the set screw 42 can be accurately located within the aperture 40 and against the flange 36 of the brush seal. Thus, the brush seal is maintained in engagement with the hook of the barrel to stabilize the brush seal and avoid flutter.

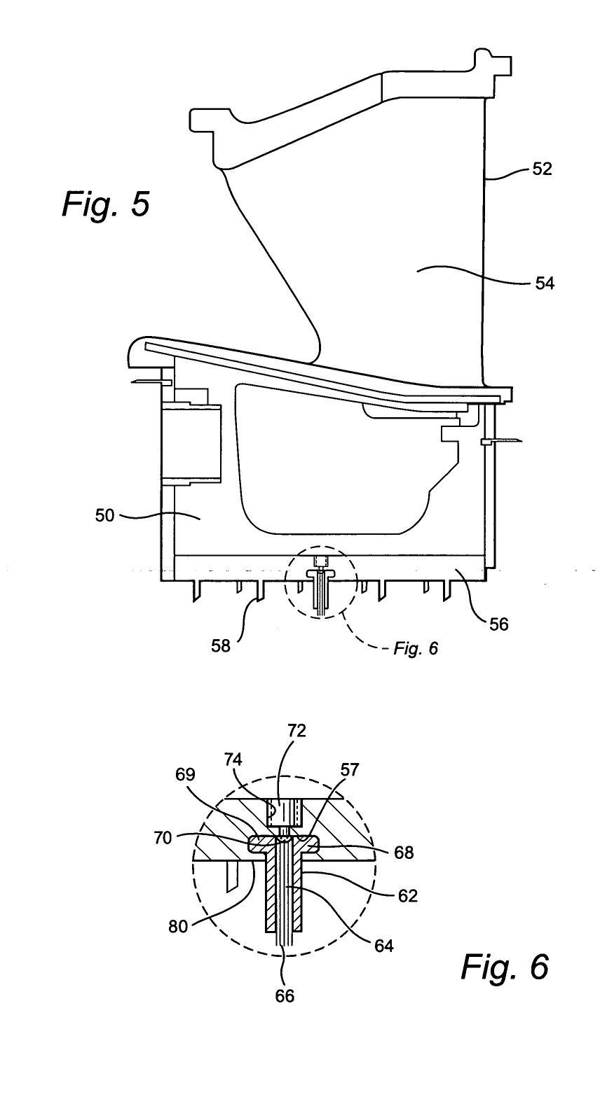

Referring now to FIGS. 5 and 6, the brush seal support may also be applied to the diaphragm 50 of a turbine. It will be appreciated from a review of FIG. 5 that the diaphragm 50 forms part of a nozzle segment 52, including a stator vane 54. The diaphragm segment is conventional in construction and need not be further described. On the inner wall 56 of the diaphragm, there is provided a plurality of labyrinth seals 58 for sealing against flow between the diaphragm and the rotor. Additionally, a brush seal similar to the brush seal previously described may be provided in the wall 56 to effect sealing and hence enhance the effectiveness of the seal at that location. The mounting structure for the brush seal in this application is the diaphragm 50 and particularly wall 56. Wall 56 has a generally T-shaped groove 57 opening radially inwardly. As illustrated, particularly in FIG. 6, the brush seal 60 includes a pair of arcuate plates 62 straddling the bristles 64 with the tips 66 of the bristles projecting for engagement with the rotor. Each of the plates 62 includes an axially extending flange 68 forming part of the base 69 of the brush seal, the plates 62 and bristles 64 being secured to one another by a weld bead 70. In this form, as in the previous form, a pin or set screw 72 is provided in an aperture 74 formed in wall 56. It will be appreciated that the apertures are located at circumferentially spaced positions along the wall 56. Two or more pins or set screws are used for each brush seal segment. The pin or set screw either threadedly engages with the aperture 74 or threadedly engages in a wire insert which, in turn, threadedly engages with the aperture, similarly as illustrated in FIG. 4. The distal tip of the pin or set screw 72 engages the brush seal along its base to maintain the flanges 68 in engagement with the hooks 80 formed along the wall 56 and defining, in part, the groove formed in the wall 56. The pin or set screw may be staked to the wall 56, similarly as illustrated in FIG. 3. The pin or set screw maintains the brush seal in accurate location in a stable manner and avoids flutter of the brush seal which detrimentally affects performance of the seal.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A seal comprising:
a brush seal segment including a base having a flange and a plurality of bristles secured to said base having distal tips for engaging a movable member;
a mounting structure for the seal having a groove for receiving the base of the brush seal and having a hook, said groove being sized to enable the brush seal bristles to project beyond a surface of the mounting structure to engage the movable member upon engagement of said brush seal flange and said hook;
at least a pair of threaded apertures extending through the mounting structure and opening into said groove;
a screw threaded into each of said apertures with an end thereof engaging said base to maintain the brush seal flange in engagement with the hook of said base; and
means connecting between said mounting structure and said screw for securing said screw in said threaded aperture.

2. A seal according to claim 1 wherein said means include staking the set screw to the mounting structure.

3. A seal according to claim 1 wherein said means includes a wire insert screwthreaded into each said aperture, said screw being threaded into said wire insert.

4. A seal according to claim 1 wherein said groove has an opening facing said movable member, said threaded apertures opening into said groove on a side thereof opposite said movable member.

5. A seal according to claim 1 wherein said groove and said base are arcuate, the tips of the bristles forming an arcuate edge of the seal for engaging a rotating member.

6. A seal according to claim 5 wherein said groove has an opening facing said movable member, said threaded apertures opening into said groove on a side thereof opposite said movable member, said means including staking the set screw to the mounting structure.

7. A seal according to claim 5 wherein said groove has an opening facing said movable member, said threaded apertures opening into said groove on a side thereof opposite said movable member, said means including a wire insert screwthreaded into each said aperture, said screw being threaded into said wire insert.

8. A turbine seal arrangement comprising:
an inner barrel about a turbine axis and having an arcuate groove opening inwardly toward the axis, said groove including an axially extending recess spaced within and back from the groove opening and defining a hook;
a rotor rotatable relative to said inner barrel;
a brush seal including an arcuate base disposed within said arcuate groove and a plurality of bristles extending from said base through said groove opening and terminating in tips engaging a sealing surface on said inner barrel, said base having a flange extending axially into said recess and engaging said hook;
a pair of apertures extending through said inner barrel into said groove from a side thereof opposite said groove opening;
a pin in each said aperture engaging a back side of said base away from said groove opening at circumferentially spaced positions about said base to maintain said flange and said hook in engagement with one another; and
means for securing each said pin in said aperture against axial movement relative to and within said aperture to maintain the bristle tips in sealing engagement with said rotor.

9. A turbine seal arrangement according to claim 8 wherein said securing means includes portions of said pin and mounting structure staked to one another.

10. A turbine seal arrangement according to claim 8 wherein said securing means includes a wire insert screwthreaded into each said aperture, said pin being threaded into said wire insert.

11. A turbine seal arrangement comprising:
a diaphragm having a generally arcuate inner wall extending about an axis, said inner wall having a groove opening inwardly toward the axis, said groove including an axially extending recess spaced within and back from the groove opening and defining a hook along said diaphragm wall;
a rotor rotatable relative to said inner wall;
a brush seal including an arcuate base disposed within said groove and a plurality of bristles extending from said base through said groove opening and terminating in tips engaging a sealing surface on said rotor, said base having a flange extending axially into said recess and engaging said hook;
a pair of apertures extending through said inner wall of the diaphragm into said groove from a side thereof opposite said groove opening;
a pin in each aperture engaging a back side of said base away from said opening at spaced positions along said inner wall to maintain said flange and said hook in engagement with one another; and
means for securing each said pin in said aperture against axial movement relative to and within said aperture to maintain the bristle tips in sealing engagement with said rotor.

12. A seal according to claim 11 wherein said securing means includes portions of the pin and the mounting structure staked to one another.

13. A seal according to claim 11 wherein said securing means includes a wire insert screwthreaded into each said aperture, said pin being threaded into said wire insert.
